(19) United States
(12) Patent Application Publication
(10) Pub. No.: US 2026/0146714 A1
(43) Pub. Date: May 28, 2026

(54) ZERO BOIL-OFF LIQUID HYDROGEN COOLED TANK

(71) Applicant: Quantum Technology Corporation, Squamish (CA)

(72) Inventors: Calvin Winter, Squamish (CA); Ovidiu Marin, Chapel Hill, NC (US); Yechun Zhang, Vancouver (CA); Elena Baglietto, Squamish (CA)

(21) Appl. No.: 19/399,499

(22) Filed: Nov. 24, 2025

Related U.S. Application Data
(60) Provisional application No. 63/724,146, filed on Nov. 22, 2024.
(60) Provisional application No. 63/922,897, filed on Nov. 21, 2025.

(51) Int. Cl. F17C 7/04; B01D 17/02; B01D 17/04

(52) U.S. Cl. CPC F17C 7/04; B01D 17/0202; B01D 17/045; F17C 2221/012; F17C 2223/0161; F17C 2227/0135; F17C 2227/0164; F17C 2227/0353; F17C 2265/037; F17C 2265/065; F17C 2270/0168; F17C 2270/0184

(57) ABSTRACT

Example methods, apparatuses, or articles of manufacture are disclosed herein that may be utilized, in whole or in part, to facilitate or support one or more operations or techniques for a reliquefaction, storage, and/or filling system, such as implemented, in whole or in part, via a zero boil-off liquid hydrogen cooled tank, for example.

### CROSS-REFERENCE TO RELATED APPLICATIONS

This application claims the benefit of priority to U.S. Provisional Application Ser. No. 63/724,146, filed Nov. 22, 2024, and to U.S. Provisional Application Ser. No. 63/922,897, filed on Nov. 21, 2025, both of which are incorporated herein by reference in their entirety.

### FIELD

The present disclosure relates generally to liquid hydrogen-related infrastructures and, more specifically, to more efficient storage and/or dispensing of liquid hydrogen, such as via a liquid hydrogen cooled tank, for example.

### BACKGROUND

Heavy-duty vehicles, such as construction and mining equipment, trucks, buses, trains, and aircrafts, for example, may use hydrogen as fuel. These or like vehicles may include specialized equipment, such as storage tanks, compressors, hydrogen dispensers, and/or cooling systems in support of utilizing hydrogen fuel.

In typical liquid hydrogen filling operations, liquid hydrogen boils off into gaseous hydrogen (GH₂). Instead of being recaptured, the boil-off gas may be vented to the atmosphere. The boil-off operation may result in significant loss of liquid hydrogen (upwards of 50% in some cases), such as during a high-pressure pumping process that may occur to fuel the heavy-duty vehicles.

Boil-off may also occur during storage of the hydrogen, such as in a vehicle storage tank. Thus, the time between production and use of liquid hydrogen may ideally be minimized to ensure there is sufficient liquid hydrogen remaining by the time of use. The loss of liquid hydrogen due to boil-off may especially be significant for applications in which liquid hydrogen is transported long distances between its production location and point of use. However, liquid hydrogen's high volumetric density compared to gaseous hydrogen makes it advantageous for transport over long distances, as relatively fewer trucks may deliver more hydrogen in its liquid state than would be possible in gaseous form. Hydrogen may be stored at cryogenic temperatures to maintain its liquid state.

Current liquid hydrogen applications may limit the adoption of hydrogen in situations which might otherwise be advantageous. Long transport distances and limited storage footprint are among the reasons liquid hydrogen delivery may be avoided. In some cases, the already high cost of hydrogen may be doubled due to the current hydrogen boil-off paradigm. These economic barriers may limit the adoption of hydrogen in some scenarios.

While using liquid hydrogen despite these economic issues, hydrogen gas venting may be concerning. Hydrogen is a powerful indirect greenhouse gas (10× per unit mass the warming potential of CO₂ based on a 100-year time horizon). For delivery systems which vent 50% of hydrogen during fueling, the greenhouse gas (GHG) benefit of switching from diesel to hydrogen may theoretically be eliminated by the GHG effect of the vented hydrogen boil-off.

Accordingly, the issues associated with the storage and transportation of liquid hydrogen continues to be an area of development.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a diagram of a cryogenic refrigeration system, according to an implementation.

FIG. 2 is a diagram of a cryogenic refrigeration system, according to an implementation.

FIG. 3 is a diagram of a cryogenic refrigeration system, according to an implementation.

FIG. 4 is a diagram of a reliquefaction, filling, and storing system, according to an implementation.

Reference is made in the following detailed description and accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other implementations may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example implementations, reference is made to specific example implementations by way of drawings and illustrations. These examples are described in sufficient detail to enable those skilled in the art to practice what is described and serve to illustrate how elements of these examples may be applied to various purposes or implementations. Other implementations exist, and logical, mechanical, and other changes may be made.

Some example apparatuses are disclosed herein that may be used, in whole or in part, to facilitate and/or support one or more operations and/or techniques for a reliquefaction, storage, and/or filling system, such as via a so-called zero boil-off liquid hydrogen cooled tank, for example. In some illustrations and descriptions, the reliquefaction, storage, and/or filling system substantially eliminates the boil-off of liquid that has previously been liquified from a gaseous state during storage of the liquid and filling of a vehicle that is to be fueled by the liquid. In other implementations, the reliquefaction, storage, and/or filling system may ensure that little or no gas is lost to the atmosphere, as non-limiting examples. For purposes of illustration, maintaining a closed system for reliquefaction of a gas may result in use of the material in liquid form in some applications that may otherwise not be considered economically feasible, although such implementations are not meant to be limited in this regard.

In implementing the reliquefaction, storage, and/or filling system, some example apparatuses are disclosed herein that may be used, in whole or in part, to facilitate and/or support one or more operations and/or techniques for a cryogenic refrigerator which may be part of the reliquefaction, storage, and/or filling system. Thus, as will be described in greater detail below, in an implementation, a reliquefaction, storage, and/or filling system is disclosed. In one or more aspects, the reliquefaction, storage, and/or filling system may mitigate or eliminate the loss of boil-off gas. The resulting liquid may be suitable for transport where the material in its gaseous state may not be economically feasible for transport. The resulting liquid may be used to fill a fuel chamber of a vehicle.

Before describing the reliquefaction, storage, and/or filling system in more detail, a description of the cryogenic refrigerator that may be implemented as part of the reliquefaction, storage, and filling system is presented herein via a non-limiting example.

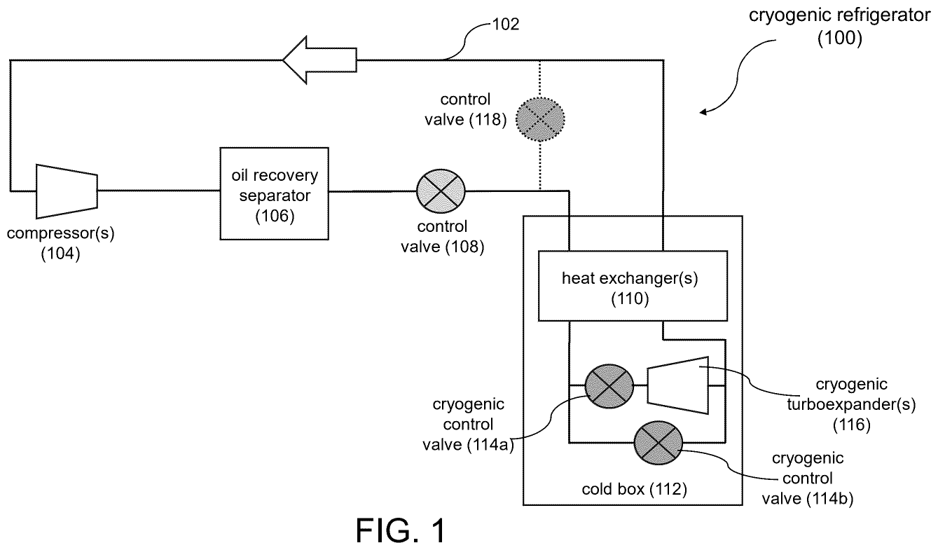

FIG. 1 is an implementation of a schematic diagram illustrating features associated with an implementation of a cryogenic refrigerator 100. The schematic is a simplified representation of cryogenic refrigerator 100, as further valves, buffer tanks, and sub-systems, including but not limited to, a purification system, are not shown in the illustration, though they may be part of cryogenic refrigerator 100. Cryogenic refrigerator 100 may cool a refrigerant to cryogenic temperatures, where the refrigerant thereafter may be used to cool another material, such as to convert a gas to a liquid. In one example, cryogenic refrigerator 100 may be used to cool hydrogen gas, resulting in liquid hydrogen. Cryogenic refrigerator 100 may comprise a conduit 102 through which refrigerant may flow between components of cryogenic refrigerator 100. In one or more non-limiting aspects, refrigerant may be helium, nitrogen, hydrogen, neon, or a mixture of any of the aforementioned components. In one or more aspects, conduit 102 may comprise material suitable for use with refrigerants at cryogenic temperatures.

In one or more non-limiting aspects, cryogenic refrigerator 100 may comprise one or more compressors 104. Where two compressors are used, one compressor may be larger than the other one, for example. Compressor(s) 104 may, as one example, be oil-lubricated screw compressor(s) comprising rotating screws that interdigitate while rotating to compress refrigerant. The rotating screws may be lubricated with oil to ensure smooth operation. In one implementation, compressor(s) 104 may be a variable frequency drive (VFD) compressor(s). Compressor(s) 104 may receive refrigerant, which may be substantially oil-free. Once refrigerant goes through compressor(s) 104, refrigerant may contain oil from the lubrication of rotating screws.

In one or more non-limiting aspects, cryogenic refrigerator 100 may comprise an oil recovery separator 106. Oil recovery separator 106 may receive refrigerant from compressor(s) 104, which may contain oil. Oil recovery separator 106 may, in one or more non-limiting aspects, contain filters, baffles, or mesh materials, and may perform operations, such as centrifugal separation, in one or multiple stages, to remove oil from refrigerant. In a non-limiting example, the amount of oil in refrigerant may be less than one part per million (ppm) concentration level following passage through oil recovery separator 106.

In one or more non-limiting aspects, cryogenic refrigerator 100 may comprise a cold box 112, which may further comprise one or more heat exchangers 110, cryogenic control valves 114a and 114b (collectively, “cryogenic control valve(s) 114”), and one or more cryogenic turboexpanders 116. In a non-limiting example, heat exchanger(s) 110 may be counterflow heat exchangers. In a non-limiting example, cold box 112 may be vacuum-insulated. Cryogenic refrigerator 100 may also comprise (room-temperature) control valve 108 to control rate of flow of refrigerant into cold box 112 and/or to perform gas purification operation before sending refrigerant to cold box 112. In a non-limiting example, control valve 108 may prevent refrigerant from entering cold box 112. Optionally, cryogenic refrigerator 100 may also comprise room-temperature control valve 118 disposed at the entrance to cold box 112, for sending refrigerant from oil recovery separator 106 back to compressor(s) 104. In one implementation, control valve 118 may provide a bypass around cold box 112 in case the cooling power is not needed by the cold box 112 but the compressor(s) 104 is still running. Thus, if the cold box 112 is at an optimum cryogenic temperature but the compressor(s) 104 is still running, the control valve 118 may be activated (opened), providing a pathway for refrigerant to return to compressor(s) 104. In another implementation, control valve 118 may facilitate pressure maintenance before refrigerant enters cold box 112. Further, control valve 118 may be used where cryogenic refrigerator 100 includes purification.

In one or more non-limiting aspects, heat exchanger(s) 110 may have two separate compartments for the refrigerant, with one compartment containing relatively warm, high-pressure refrigerant, and another compartment containing relatively cold, low-pressure refrigerant. In a non-limiting example, refrigerants may be compartmentalized, and thus may not mix, but heat may transfer from the relatively warmer refrigerant stream to the colder one. Heat exchanger(s) 110 may thus both cool incoming warm refrigerant before entering cryogenic turboexpander(s) 116 and reheat colder refrigerant before entering the compressor(s) 104. Heat exchanger(s) 110 may be used to pre-cool high-pressure refrigerant during different stages of cryogenic refrigerator 100.

In one or more non-limiting aspects, cryogenic turboexpander(s) 116 may receive refrigerant, which may be cold and at high pressure. Cryogenic control valve 114a may allow refrigerant to enter cryogenic turboexpander(s) 116 while cryogenic control valve 114b may allow refrigerant to bypass cryogenic turboexpander(s) 116.

In one or more non-limiting aspects, turbine(s) within the cryogenic turboexpander(s) 116 may rotate at a very high speed (e.g., anywhere from 60,000 to 200,000 rpm or more) and may comprise a specialized gas bearing to further cool the refrigerant, which may thereafter be used to cool a material. In a non-limiting example, cryogenic turboexpander(s) 116 may be hydrostatic or hydrodynamic gas bearing-type of cryogenic turbine expander(s).

The material to be cooled by cryogenic refrigerator 100 may, in one or more non-limiting aspects, be a material that benefits from cryogenic refrigeration. Hydrogen, for example, may become a liquid when cooled to approximately −253° C. Further, as a liquid, hydrogen occupies about 1/848^{th} of its original gaseous volume. Thus, it may be more economical to store and transport hydrogen in its liquid state, making cryogenic refrigeration a cost-effective solution for hydrogen.

In one or more non-limiting aspects, cryogenic turboexpanders may be quite small (its impeller may, for example, be about the size of a human thumb) and may run at very high speeds. Because of its diminutive size, it does not take much energy to overspeed the turbine in cryogenic turboexpander. A cryogenic turboexpander rotor may, for example, be running at 120,000 rpm, but may quickly ramp up to over 300,000 rpm in a fraction of a second, which may permanently damage the turbine and break the cryogenic turboexpander. For this reason, each of the one or more cryogenic turboexpanders may be surrounded by sometimes several cryogenic control valves. High-performance cryogenic control valves may cost ten times the price of a room-temperature control valve or more, due to operating in low-temperature environments and specific control requirements. Further, a cryogenic turboexpander may be coupled with a buffer tank to supply reserve gas, such as in the event of a complete shutdown.

In one or more non-limiting aspects, cryogenic control valves 114 may be used to control ramp-up speed of the turbine in cryogenic turboexpander(s) 116, which may control the flow of refrigerant into and out of cryogenic turboexpander(s) 116. Because the turbine(s) of cryogenic turboexpander(s) 116 may overspeed if there is too little pressure at the outlet or too little gas flow rate at the inlet, other valves (not shown) may provide an adequate amount of buffer gas to allow the turbine rotor to reduce speed as desired. Cryogenic control valve 114a may control refrigerant entering cryogenic turboexpander(s) 116 while cryogenic control valve 114b may control refrigerant entering a bypass line around cryogenic turboexpander(s) 116.

In one or more non-limiting aspects, cryogenic refrigerator 100 may optionally comprise control valve 118, disposed between the entrance of cold box 112 and compressor(s) 104. Although two room-temperature control valves 108 and 118 and three cryogenic control valves 114a and 114b are shown in FIG. 1, cryogenic refrigerator 100 may comprise many room-temperature control valves and cryogenic control valves.

In one or more non-limiting aspects, the ramp-up speed of the cryogenic turboexpander(s) 116 may be carefully managed by controlling pressures and flows (using the cryogenic control valves 114) and by providing an adequate amount of buffer gas to allow the rotor to gradually slow down during an emergency.

In one or more non-limiting aspects, the cryogenic refrigerator 100 may have some disadvantages. The oil recovery separator 106 may be indispensable due to the use of oil to lubricate compressor(s) 104. Otherwise, oil contaminating the refrigerant may freeze on the turboexpander blades and cause catastrophic damage. However, the oil recovery separator 106 may substantially increase capital and operating costs, as well as having a significant size and mass, thus increasing the overall size of cryogenic refrigerator 100. Cryogenic refrigerator 100 may have a purifier (not shown) for removing gas contaminants, as the oil recovery separator 106 is designed for oil removal, rather than other gaseous contaminants.

In one or more non-limiting aspects, the oil recovery separator 106 may further use a substantial volume of refrigerant, which may render it costly to fill and service. In addition, since pressure of refrigerant to cryogenic turboexpander(s) 116 may not be changed quickly, the state of the art may be to use several valves, including cryogenic valves, to control the flow of refrigerant to cryogenic turboexpander(s) 116. Cryogenic valves (e.g., cryogenic control valves 114) are expensive devices, relative to non-cryogenic control valves (e.g., control valves 108 and 118), and each additional control valve may further add to the complexity and cost of the cryogenic refrigerator 100. Further, because the flow rate of refrigerant may be closely monitored to protect cryogenic turboexpander(s) 116, the cryogenic refrigerator 100 may include many more sensors disposed along conduit 102 than might otherwise be needed.

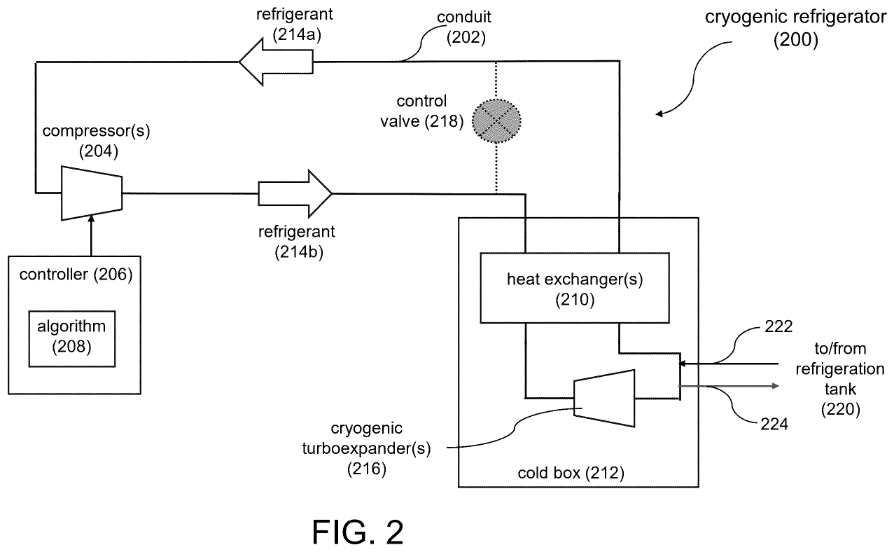

FIG. 2 is a schematic diagram illustrating features associated with an implementation of a cryogenic refrigerator 200. Cryogenic refrigerator 200 may cool a refrigerant 214 to cryogenic temperatures, where the refrigerant thereafter may be used to cool another material, such as to convert a gas to a liquid. In one example, cryogenic refrigerator 200 may be used to cool hydrogen gas, resulting in liquid hydrogen production. Cryogenic refrigerator 200 may comprise a conduit 202 through which refrigerant 214a and 214b (collectively, “refrigerant(s) 214”) flows between components of cryogenic refrigerator 200. In one or more non-limiting examples, cryogenic refrigerator 200 may comprise one or more compressors 204, a cold box 212 comprising one or more heat exchangers 210 and one or more cryogenic turboexpander(s) 216.

In one or more non-limiting aspects, conduit 202 may be a specially insulated pipe suitable for use with fluids and/or gases flowing therethrough at temperatures approaching cryogenic temperatures. Refrigerant 214 may be any of a number of different gases that may be liquefied at cryogenic temperatures, including, but not limited to helium, hydrogen, or neon, or mixtures of gases, such as a helium neon mixture. In one or more non-limiting aspects, cryogenic refrigerator 200 may utilize vacuum-insulated cryogenic expansion engine to effectively provide cooling below 20° Kelvin.

Where two compressors 204 are used, one compressor may be larger than the other one, for example. In one or more non-limiting examples, compressor(s) 204 may be oil-free compressors. In such case, cryogenic refrigerator 200 may therefore be implemented without an oil recovery separator, such as the oil recovery separator 106 used in cryogenic refrigeration system 100 (FIG. 1). In one or more non-limiting examples, compressor(s) 204 may be variable-speed compressor(s), with one or more speeds of the compressor(s) 204 being controllable using software, firmware, hardware, or a combination thereof.

In one or more non-limiting examples, cryogenic refrigerator 200 may comprise a controller 206 with an algorithm 208 for controlling various operating speeds of compressor(s) 204. In one implementation, compressor(s) 204 may be variable frequency drive (VFD) compressor(s). Although shown external to compressor(s) 204, controller 206 and algorithm 208 may be an integrated part of compressor(s) 204. Algorithm 208 may be implemented in software, firmware, hardware, or a combination of these. In one or more non-limiting examples, algorithm 208 may be implemented as a software program, with controller 206 comprising a processor and memory, with software being loaded into memory and executed by processor.

In one or more non-limiting examples, cryogenic refrigerator 200 may comprise a plurality of sensors (not shown). Sensor may be disposed on an input or output of compressor(s) 204, cryogenic turboexpander(s) 216, or other components of cryogenic refrigerator 200. Controller 206 may be capable of sensing data from sensors. Sensors may communicate wirelessly with controller 206 using Bluetooth, Zigbee, or using other wireless communication protocols, as non-limiting examples. Thus, controller 206 may be aware of flow rate into cryogenic turboexpander(s) 216, as one example. Further, in one or more aspects, software executing algorithm 208 may receive data from one or more sensors of cryogenic refrigerator 200.

In one or more non-limiting examples, execution of algorithm 208 in controller 206 may cause adjustment of the speed of compression operations inside compressor(s) 204, adjustment to the capacity of the space holding refrigerant 214a within compressor(s) 204, or adjustment of flow rate of refrigerant 214a through compressor(s) 204, any of which may modify a flow rate of refrigerant 214b out of compressor(s) 204. These adjustments may occur by activation of actuators in compressor(s) 204, as one non-limiting example.

In one or more non-limiting examples, controller 206 may control the speed or capacity (flow rate) of compressor(s) 204, a variable-speed device. In one or more aspects, the ability to control the speed or capacity (flow rate) of refrigerant leaving compressor(s) 204 (as refrigerant 214b) may render at least one of the control valves present in refrigerator 100 redundant (see, e.g., control valve 108 in FIG. 1). In one or more non-limiting examples, the capacity of cryogenic refrigerator 200, such as cooling power, flow rate, pressure, control valves used, etc., may be adjusted via algorithm 208 of controller 206. As one example, the algorithm 208 may change the speed (capacity) of compressor(s) 204 via its variable-speed capability to get a different amount of cooling capacity out of the cryogenic refrigerator 200.

In an example implementation, refrigerant 214a may enter compressor(s) 204 and, after compression occurs, may emerge as refrigerant 214b. Because compressor(s) 204 may operate without the use of oil as a lubricant, refrigerant 214b may likewise be oil-free. Thus, cryogenic refrigerator 200 may be implemented without an oil recovery separator.

In one or more non-limiting examples, cold box 212, which may be vacuum insulated, may comprise heat exchanger(s) 210 and cryogenic turboexpander(s) 216. In one or more non-limiting examples, cryogenic refrigerator 200 may include fewer regular and cryogenic control valves than cryogenic refrigerator 100. Instead, in one or more non-limiting examples, compressor(s) 204 may control flow of refrigerant 214b into cold box 212.

In one implementation, additional conduits 222 and 224 may be disposed between cryogenic turboexpander(s) 216 and heat exchanger(s) 210 and a refrigeration tank 220. Refrigeration tank 220 which, in one implementation, is not part of cryogenic refrigerator 200, may be used to store a liquid, such as liquid hydrogen (LH2) that has been cooled from its original gaseous state. Refrigerant 214 that has been cooled in cold box 212 may be fed through conduit 214 into refrigeration tank 220 to maintain the stored liquid at a certain (cryogenic) temperature in refrigeration tank 220. Similarly, refrigerant 220 may be sent from refrigeration tank 220 back into cold box 212. The stored liquid, such as LH2, may not mix with the refrigerant 214, as they are maintained separately. As one non-limiting example, the LH2 may be stored in the vessel (refrigeration tank 220) while the refrigerant is stored in conduits distributed throughout the vessel.

In one or more non-limiting examples, heat exchanger(s) 210 may be used to pre-cool high-pressure refrigerant 214 during different stages of cryogenic refrigerator 200. In a non-limiting example, heat exchanger(s) 210 may be counterflow heat exchangers, with a first heat exchanger, for example, pre-cooling refrigerant 214b prior to being received into cryogenic turboexpander(s) 216 while a second heat exchanger transfers cold refrigerant to refrigeration tank 220 (or back to compressor(s) 204). This may, in whole or in part, allow for a more efficient system by making the return refrigerant 214a warmer instead of sending cold refrigerant out of the cold box 212 and wasting the cold to the atmosphere.

In one or more non-limiting examples, cryogenic refrigerator 200 may optionally comprise a control valve 218 disposed between cold box 212 and compressor(s) 204. In one implementation, control valve 218 may provide a bypass around cold box 212 for flow of refrigerant 214. For example, the cooling power may not be needed by the cold box 212 but compressor(s) 204 may still be running. Thus, if the cold box 212 is at an optimum cryogenic temperature but the compressor(s) 204 is still running, the control valve 218 may be activated (opened), providing a pathway for refrigerant 214b to return to compressor(s) 204. Further, in one implementation, cryogenic refrigerator 200 may have a purifier (not shown) for removing gas contaminants, such as nitrogen and oxygen, from the system.

In one or more non-limiting examples, cryogenic turboexpander(s) 216 may receive refrigerant 214b, which may be cold and at high pressure. Turbine(s) within cryogenic turboexpander(s) 216 may rotate at a very high speed (e.g., 300,000 rpm or more) and may comprise specialized gas bearings to substantially mitigate or eliminate friction between the stator and rotor of cryogenic turboexpander(s) 216. In one implementation, the gas bearings may allow the cryogenic turboexpander(s) 216 to spin at a fast enough speed, resulting in refrigerant 214 being cooled to cryogenic temperatures. In a non-limiting example, cryogenic turboexpander(s) 216 may be a hydrostatic or hydrodynamic gas bearing type of cryogenic turbine expander.

Recall that cryogenic turboexpanders may be quite small, run at very high speeds, and run the risk of overspeed, which may cause them to break. Thus, controlling flow of refrigerant may ensure a long working life of cryogenic turboexpander(s) 216. In one or more non-limiting aspects, compressor(s) 204 may control the flow of refrigerant 214b to cryogenic turboexpander(s) 216. More specifically, execution of algorithm 208 in controller 206 may control flow rate of refrigerant 214b to cryogenic turboexpander(s) 216, thus potentially reducing the number of room-temperature and/or cryogenic control valves used in cryogenic refrigerator 200.

In one or more non-limiting aspects, cryogenic refrigerator 200 may eliminate the use of oil recovery separator, due to compressor(s) 204 being oil-free, and may reduce number of room-temperature or cryogenic control valves, due to compressor(s) 204 being variable-speed and controllable via algorithm 208. In an example implementation, cryogenic refrigerator 200 may employ a simplified piping and control system, as compared to cryogenic refrigerator 100, which may result in an overall reduction in the number of expensive cryogenic valves.

In one or more non-limiting aspects, the number of process control sensors may be reduced due to the elimination of the oil recovery separator and one or more cryogenic control valves. Cryogenic refrigerator 200 may provide a significant reduction in complexity and thus a reduction in capital cost, as well as an improvement in reliability over prior art cryogenic refrigeration systems. In an example implementation, eliminating the use of an oil recovery separator may result in a reduction in the volume of refrigerant. In one or more non-limiting examples, cryogenic refrigerator 200 may use more costly mixed gas refrigerants, such as helium neon mix, which may be advantageous for the refrigeration cycle of some implementations.

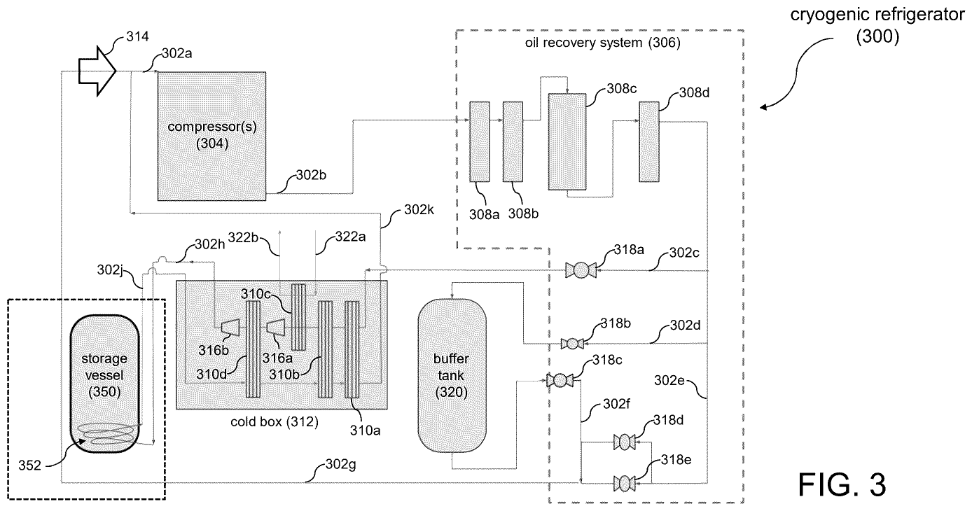

FIG. 3 is a schematic diagram illustrating features associated with an implementation of a cryogenic refrigerator 300. Cryogenic refrigerator 300 may cool a refrigerant 314 to cryogenic temperatures, where the refrigerant thereafter may be used to cool another material, such as to convert a gas to a liquid. In one example, cryogenic refrigerator 300 may be used to cool hydrogen gas, resulting in liquid hydrogen.

Cryogenic refrigerator 300 may comprise conduits 302a-j (collectively, “conduit(s) 302”) through which refrigerant 314 may flow between components of cryogenic refrigerator 300. In one or more non-limiting examples, cryogenic refrigerator 300 may comprise one or more compressors 304, an oil recovery system (ORS) 306, a cold box 312 comprising heat exchangers 310a-d (collectively, “heat exchanger(s) 310”) and cryogenic turboexpanders 316a-b (collectively, “cryogenic turboexpander(s) 316”), a plurality of valves 318a-e (collectively, “valve(s) 318”), and a buffer 320. In a non-limiting implementation, cryogenic refrigerator 300 may be coupled to an external storage vessel.

In one or more non-limiting aspects, conduits 302 may be specially insulated pipes suitable for use with cryogenic fluids flowing. Refrigerant 314 may be any of a number of different gases that may be liquefied at cryogenic temperatures, including, but not limited to helium, hydrogen, nitrogen, or neon, or mixtures of gases. In an example implementation, refrigerant 314 may be a mixed refrigerant, such as a helium neon mixture. In one or more non-limiting aspects, cryogenic refrigerator 300 may utilize vacuum-insulated cryogenic expansion engine to effectively provide cooling below 20° Kelvin.

Where two compressors 304 are used, one compressor may be larger than the other one, for example. In one or more non-limiting examples, one or more of compressor(s) 304 may be oil-flooded screw compressors. Cryogenic refrigerator 300 may therefore be implemented with oil recovery system 306. The compressor(s) 304 is designed to compress the refrigerant 314 as it comes into the cryogenic refrigerator 300.

In one implementation, refrigerant 314 may enter compressor(s) 304 through conduit 302a at close to atmospheric pressure. Refrigerant 314, upon leaving compressor(s) 304 may enter conduit 302b at a higher pressure. In one non-limiting example, refrigerant, upon leaving compressor(s) 304 may enter conduit 302b at approximately 16 barg 750. The refrigerant 314 may thus enter the oil recovery system 306 at a pressure significantly higher than when entering the cryogenic refrigerator 300.

In one implementation, the oil recovery system 306 may include multiple filters, such as filters 308a, 308b, 308c, and 308d. Filters 308 may be aligned serially, such as in FIG. 3. These filters 308 may receive refrigerant 314 from conduit 302b after refrigerant 314 leaves compressor(s) 304. For example, filters 308a and 308b may be coalescing filters, filter 308c may be a carbon filter, and filter 308d may be a particulate (dust) filter. These filters may remove oil that may collect in the refrigerant 314 as it passed through the compressor(s) 304. Filters 308 may be arranged in an order different from the illustration of FIG. 3. Oil recovery system 306 may not be limited to the types of filters shown and described herein.

In one non-limiting example, coalescing filters 308a and 308b are implemented in two to three stages, with a maximum allowable working pressure (MAWP) of 18 barg minimum. In one non-limiting example, coalescing filter 308a may reduce the oil particulate content in refrigerant 314 to about 1 part per million (ppm) while coalescing filter 308b may reduce the oil particulate content in refrigerant 314 to about 0.1 or 0.01 ppm. The filters 308a and 308b may include outlets for purging the filtered oil contaminants. In one aspect, the pressure drop through the filters 308 results in utilizing a larger compressor, thus potentially increasing the cost of the cryogenic refrigerator.

In one implementation, carbon disposed in the carbon filter 308c may absorb oil vapor (gas) as well as oil in particulate droplet form (liquid) from the refrigerant 314. Refrigerant 314 leaving carbon filter 308c may have very low parts per billion of oil, so as to keep the cryogenic turboexpanders 316 safe. Carbon pellets disposed inside filter 308c may be periodically emptied and replaced with fresh carbon pellets. Particulate filter 308d may remove any final gas or liquid oil particulates, as well as any carbon that may have been collected in the carbon filter 308c.

Once leaving filter 308d of oil recovery system 306, in one implementation, oil may be substantially removed from refrigerant 314. In one non-limiting example, refrigerant 314 may exit filter 308d at approximately 15 barg, with less than 0.01 ppm of oil remaining in the refrigerant 314, enabling refrigerant 314 to safely be fed into cryogenic turboexpanders 316. The refrigerant 314 thus may enter the cryogenic refrigerator 300 at a low pressure, may leave the compressor(s) 304 at a substantially higher pressure coupled with oil, then, once leaving the filters 308 of the oil recovery system 306, its high pressure may be maintained, and the oil may be substantially removed from the refrigerant 314.

In one aspect, the cryogenic refrigerator 300 implements a gap management system. Gap management involves control and optimization of interaction of components in a cryogenic environment. For example, the amount of gas, its temperature, and pressure may be carefully managed between different components, particularly to protect the cryogenic turboexpanders 316, but to ensure lasting performance of all components as well as efficient heat transfer. As one non-limiting example, the buffer tank 320 and one or more control valves 318 may be utilized for gap management. As another non-limiting example, the cryogenic refrigerator 300 may comprise one or more cryogenic valves (not shown) to regulate the power delivered to the turboexpanders 316.

As one example, refrigerant 314 leaving filter 308d of oil recovery system 306 may enter conduits 302c and 302d. If valve 318a is opened, refrigerant 314 enters the cold box 312. In one implementation, the cold box 312 may be vacuum-insulated. If valve 318b is opened, refrigerant 314 may enter the buffer tank 320. As another non-limiting example of gap management, the strategic opening and closing of valves may facilitate efficient initial operation of the cryogenic refrigerator 300, as the cold box 312 may, in an initial state, be close to room temperature. The refrigerant 314 may, for example, become more dense as its temperature decreases, at which point the introduction of more gas into the system may be appropriate. The buffer tank 320 thus is available both to store refrigerant 314 and to make refrigerant 314 available as needed. The buffer tank 320 and the valves 318a and 318b thus may provide stabilization during fluctuations in the system.

As another example, refrigerant 314 leaving filter 308d of oil recovery system 306 may enter conduit 302e. If valve 318e is opened, refrigerant 314 may travel through conduit 302g to be received back into compressor(s) 304. Or valve 318d may be opened such that refrigerant 314 enters 302f. If valve 318c remains closed, refrigerant will travel through conduit 302g and return to compressor(s) 304. However, if valve 318c is opened, refrigerant 320 may enter buffer tank 320.

In one implementation, valves 318d and 318e may work together, with one valve providing a coarse (relatively larger) controlled pathway for refrigerant 314 while the other valve provides a finer (relatively smaller) controlled pathway. This coordination between valves 318d and 318e enables precise flow and pressure control of refrigerant 314 through the cryogenic refrigerator 300. The return of the refrigerant 314 to compressor(s) 304 may be less desirable (efficient) than sending it to the cold box 312 or buffer tank 320. However, due to gap management concerns, the provision for such a pathway may nevertheless be available to ensure safe movement of the high-pressure refrigerant 314 through the cryogenic refrigerator 300. Additionally, in one implementation buffer tank 320 may be filled with refrigerant from an external source, such as during initialization of the cryogenic refrigerator 300.

Once entering the cold box 312, the refrigerant 314 may pass through multiple heat exchangers 310 and cryogenic turboexpanders 316. Heat exchangers 310 may be used to pre-cool high-pressure refrigerant 314 before being received into the cryogenic turboexpanders 316. In the implementation of FIG. 3, refrigerant 314 may traverse through heat exchanger 310a, heat exchanger 310b, cryogenic turboexpander 316a, heat exchanger 310d, and cryogenic turboexpander 316b before leaving cold box 312 via conduit 302h. As the refrigerant 314 flows through the cold box 312, its temperature may drop in successive stages. Refrigerant 314 entering heat exchanger 310a may be at 300K while the same refrigerant leaving cryogenic turboexpander 316b may be at 16K, for example.

In one implementation, the refrigerant 314 may enter conduit coils 352 of a storage vessel 350, where the storage vessel 350 may house a liquefaction product, such as liquid hydrogen (LH₂). The storage vessel 350 may be part of the cryogenic refrigerator 300 or may be part of a separate system (such as at a customer site). The refrigerant 314 thus may keep the liquid hydrogen cooled inside the storage vessel 350. The storage vessel 350 represents one particular implementation of using the refrigerant 314. In one implementation, the cryogenic refrigerator 300 may comprise one or more cryogenic valves (not shown) to manage temperature of the liquefaction material during transfer to the storage vessel 350.

In one implementation, all or part of the refrigerant 314 may leave the storage vessel 350 and return to the cold box 312. In the implementation of FIG. 3, the refrigerant 314 may pass through conduit 302j to enter the cold box 312, and may travel through heat exchanger 310d, heat exchanger 310b, and heat exchanger 310a, and may then travel through conduit 302k and 302a to return to compressor(s) 304.

In one implementation, the cold box 312 may comprise a separate mechanism for cooling down the cold box 312. Conduit 322a enables a second refrigerant, a cryogenic liquid, to be fed into the cold box 312 and sent to the heat exchanger 310c in the cold box 312. The heat exchanger 310 (which may comprise multiple heat exchangers, such as where counterflow heat exchangers are used) may then further cool the cryogenic liquid. In one implementation, the cryogenic liquid may be liquid nitrogen (LN₂). In one implementation, the cryogenic liquid is fed into the cold box 312 at startup of the cryogenic refrigerator 300, so that the turboexpanders 316 may be started gradually. For example, using the LN₂, the cold box 312 may be cooled to 80K before receiving the refrigerant 314. Gaseous nitrogen (GN₂) may then exit the cold box 312 via conduit 322b.

In one implementation, substantial care may be taken with the cryogenic turboexpanders 316. A low current, for example, may be used to slowly initialize the cryogenic turboexpanders 316. Further, the cryogenic turboexpanders 316 may be lubricated using bearing gas to ensure the moving parts therein, such as rotors or stators, do not contact one another. Thereafter, the cryogenic turboexpanders 316 may operate at a very high speed (e.g., 200,000 RPM).

In one implementation, the cryogenic refrigerator 300 may have a purifier (not shown) for removing gas contaminants, such as nitrogen and oxygen, as well as trace hydrocarbons and oils, from the system. A purifier in the cryogenic refrigerator 300 may be coupled with one or more cryogenic valves (not shown), such as ones disposed on either side of the purifier, to isolate the purifier from the rest of the system. In one implementation, the cryogenic valves close when the purifier may be saturated with impurities, and may thus prevent the turboexpanders 316 from being contaminated. The cryogenic refrigerator 300 may have one or more additional cryogenic valves, such as a bypass heating valve (not shown) to remain closed under normal conditions, but which may open to quickly warm the system by circulating warm gaseous material, such as the material to be cooled, through the cold box 312.

One or more components of the cryogenic refrigerator 300 may be installed on a self-contained module (skid) such that the cryogenic refrigerator 300 may be suitable for transport. In one example, the skid enables coupling of the cryogenic refrigerator 300 to the storage vessel 350, which may be transported in a distinct location, whether the cryogenic refrigerator 300 is moved to the location of the storage vessel 350 or vice-versa. In an example implementation, the skid may be built according to the International Organization for Standardization (ISO).

The cryogenic refrigerators 100, 200, and 300 represent particular implementations. Many different variations to the components described herein are possible. In many cases, particular aspects, features or devices may be optional. For example, where compressors using oil are found in some implementations, other implementations may use oil-free compressors. In certain implementations, it may be beneficial to select a gas purification system to work in connection with specific compressors to ensure that the flow of gas and the capacity or the power supply is sufficient. In other implementations, the gas purification system may be based on customer needs or preferences. Turbo expanders may be disposed in series or in parallel. Heat exchanges may come in different shapes and may be arranged other than as schematically shown. A number of factors may influence the design choice implementing a cryogenic refrigeration system.

### Reliquefaction, Storage, and Filling System

The above-described cryogenic refrigeration may be part of a reliquefaction, storage, and filling system, as described below.

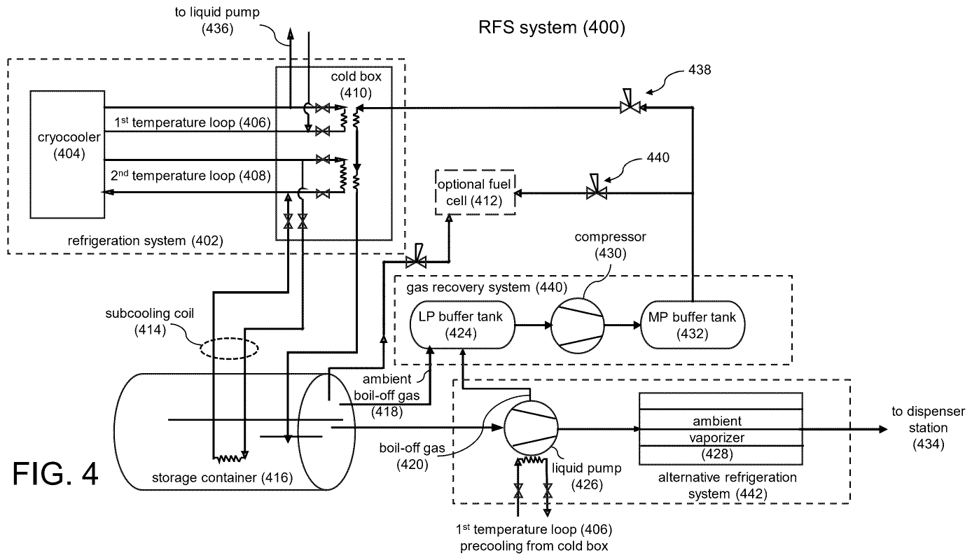

FIG. 4 is a schematic diagram illustrating features associated with an implementation of a reliquefaction, storage, and filling (RFS) system 400. In one or more non-limiting aspects, RFS system 400 may be used to both liquify and reliquefy a gas, store the resulting fluid, and fill the fuel tank of a vehicle that may operate using the liquefied fluid. Optionally, by returning the liquified fuel to gaseous form at the dispensing station, RFS system 400 may be used to fill the fuel tank of a vehicle that may operate using gas as a fuel. In a non-limiting example implementation, the gas that is reliquefied is hydrogen and the refrigerant is liquid hydrogen (LH2).

Reliquefaction is the process of reconverting a gas to a liquid. There may be an initial liquefaction operation in which the gas may be converted into a liquid. Some of the liquified gas may vaporize and turn back into gas during heat transfer, such as in a cryogenic chamber. Known as boil-off gas, the vapor may be captured and cooled down again, with the objective of converting all the vaporized gas back into liquid form. The industry term, “reliquefaction” thus refers to the second part of a two-step process in which boil-off gas from an initially converted liquid is re-liquified.

In one or more non-limiting aspects, RFS system 400 may comprise a reliquefaction storage and filling system that eliminates the loss of boil-off gas. As will be described in greater detail below, in an implementation, RFS system 400 may eliminate the loss of boil-off hydrogen gas using the following components: a refrigeration system including a sub-cooling coil, a boil-off gas recovery system, and a liquid pump coupled to an alternative refrigeration system. Components of RFS system 400 may be used in combination or individually. A schematic of RFS system 400 is illustrated in FIG. 4.

In one or more aspects of the RFS system 400, a refrigeration system 402 may use a subcooling coil 414 to cool an incoming gas into a liquid. In one implementation, refrigeration system 402 may consist of a cryocooler 404, a cold box 410, and a subcooling coil 414. In one or more aspects, the components of the refrigeration system 402 may be vacuum-jacketed, such as with a material that helps to maintain very low (cryogenic) temperature of their contents. Cryogenic temperatures generally refer to temperatures in the range of −150° C. to −273° C. (123° K to ˜0° K).

In an example implementation, subcooling coil 414 may use a liquid such as, in one non-limiting example, liquid helium, as the refrigerant for cooling a gas into a liquid (material to be liquefied). In a non-limiting aspect, subcooling coil 414 may be made up of one or more temperature loops, such as a first temperature loop 406 and a second temperature loop 408. First temperature loop 406 may operate at a first temperature while second temperature loop 408 may operate at a second temperature, where the first temperature may be different from the second temperature. In one implementation, first temperature loop 406 may operate in a range between 50° K and 150° K, preferably at a temperature around 80° K. In one implementation, second temperature loop 408 may operate in a range between 15° K and 30° K, preferably at a temperature around 20° K. Although refrigeration system 402 shows two temperature loops, there may be more or fewer temperature loops than are shown, as the illustration of FIG. 4 is meant as a non-limiting example.

RFS system 400 may comprise a valve 438 for receiving a gas to be cooled into a liquid (material to be liquefied), where the gas may, in one implementation, be hydrogen gas. The gas may then be fed into cold box 410 of refrigeration system 402, where refrigerant (e.g., liquid helium) of subcooling coil 414 may move through one or more of first temperature loop 404 and second temperature loop 404 between cryocooler 404 and cold box 410 to cool the received gas disposed in cold box 410 until the gas becomes a liquid. Once in liquid form (e.g., liquid hydrogen, LH2), the liquefied material may be transferred to a storage container 416. In whole or in part, subcooling coil 414 may allow the material to be liquefied to be subcooled below its boiling temperature during storage and before filling operations. The subcooling may, in an example implementation, reduce the boil-off during delivery from 50% to approximately 20%.

In one aspect, cryocooler 404 may comprise a closed system holding refrigerant with conduits disposed between cryocooler 404, cold box 410, storage container 416, and a liquid pump 426, the latter of which is described further below. The gas being converted to liquid may also be part of a separate closed system, where the gas may be fed into the RFS system 400 through valve 438, moves into the cold box 410 where it may be cooled by the cryocooler 404, then, once in liquid form, may be stored in the storage container 416. The closed system of the refrigerant may be separate from the closed system of the gas being cooled to a liquid, ensuring that there is no mixing between refrigerant and gas/liquid.

In one implementation, as much as 20% of liquid in storage container 416 may be boiled off as gas. In one or more aspects of RFS system 400, a gas recovery system 440 may capture, compress, and reliquefy ambient-boil-off gas 418 from storage container 416. In an example implementation, gas recovery system 440 may comprise a low-pressure (LP) buffer tank 424, a compressor 430, and a medium-pressure (MP) buffer tank 432. As will be described in greater detail below, in an implementation, gas recovery system 440 may convert ambient-boil-off gas to a liquid state for return to refrigeration system 402.

As previously described, storage container 416 may store received gas in liquid form, such as liquid hydrogen. Subcooling coil 414, shown as part of refrigeration system 402, may also be part of storage container 416 to maintain stored liquid at cryogenic temperatures. Nevertheless, some liquid in storage container 416 may return to a gaseous form, shown in FIG. 4 as ambient boil-off gas 418.

In an example implementation, gas recovery system 440 may receive ambient boil-off gas 418 into LP buffer tank 424. Ambient boil-off gas 418 may then be fed into compressor 430 to compress the gas. In one implementation, compressor 430 may be a screw compressor. Compressed gas, which may be converted by compressor 430 into liquid form, may then be stored in MP buffer tank 432. In an example implementation, as illustrated in FIG. 4, MP buffer tank 432 may be connected by conduit to valve 438, enabling compressed gas to be fed back into refrigeration system 402 as part of a closed system.

Ambient boil-off gas 418 may already be quite cold (as compared to gas entering RFS system 400 through valve 438). The quantity of ambient boil-off gas 418 may be small relative to that coming into RFS system 400. For at least these reasons, in one implementation, the size of gas recovery system 440 may be smaller relative to components of refrigeration system 402.

In one or more aspects of RFS system 400, an alternative refrigeration system 442 may recover boil-off gas from pumped fluid as the fluid is being delivered outside RFS system 400, such as to a dispenser station 434, whether the fluid may be made available to a vehicle (for fuel) or another storage facility. In one or more aspects, alternative refrigeration system 442 may include a liquid pump 426 and an optional ambient vaporizer 428. In one implementation, liquid pump 426 may pump liquid from storage container 416 to dispenser station 434. Liquid pump 426 may be cooled, in whole or in part, by subcooling coil 414, such as first temperature loop 406 precooling from cold box 410. Alternatively, liquid pump 426 may be cooled by an alternative refrigeration system (not shown). In one or more aspects, cooling liquid pump 426 may reduce the boil-off by pumping the liquid from storage container 416 to dispenser station 434 and, further, may improve the delivery flow rate of liquid to dispenser station 434.

Boil-off gas 420 may result from transfer of liquid from liquid pump 426 to LP buffer tank 424. Rather than having boiled off gas lost to the environment, in one implementation, boil-off gas 420 may be fed into LP buffer tank 424 of gas recovery system 440, compressed (by compressor 430), stored in MP buffer tank 432, and fed back into refrigeration system 420 via valve 438.

In some instances, ambient boil-off gas 418 occurs while liquid is stored in storage container 416 while boil-off gas 420 occurs while liquid flows through liquid pump 426. In both instances, in an implementation, boil-off gas is fed into LP buffer tank 424 for processing back to refrigeration system 402.

Once cooled, liquid pump 426 may deliver pressurized liquid to directly to dispenser station 434, for receipt by a customer. Alternatively, in one implementation, pressurized liquid may be delivered an ambient vaporizer 428, which may flash boil the liquid for delivery in gaseous form, including, but not limited to, deliver to a customer's gas-receiving fuel tank, such as a gaseous hydrogen fuel tank. RFS system 400 may thus deliver fuel to customers having gas-based fuel systems and to customers having liquid-based fuel systems.

By implementing a closed-loop system, RFS system 400 may ensure that no gas is lost to the atmosphere. Further, in one aspect, the liquid level in RFS system 400 may remain constant, even after long storage or transport periods. In an example implementation, no gas may be lost to the atmosphere during filling operations, which may reduce economic loss as well as the greenhouse gas effect of venting gases.

In an example implementation, RFS system 400 may be skid-mounted and designed for easy road transportation to customer sites. An optional fuel cell 412 may be used to power RFS system 400 for remote sites without access to power sources. Alternatively, RFS system 400 may be powered via local mains electricity or some other power source.

In one implementation, the refrigeration system 402 of the RFS system 400 may be implemented using the cryogenic refrigerator 100 of FIG. 1. In a second implementation, the refrigeration system 402 of the RFS system 400 may be implemented using the cryogenic refrigerator 200 of FIG. 2. Such an implementation may be advantageous where fewer control valves are preferred. In a third implementation, the refrigeration system 402 of the RFS system 400 may be implemented using the cryogenic refrigerator 300 of FIG. 3. Such an implementation may be advantageous due to stabilization of pressure due to the buffer zone.

Even though a certain number of devices may be illustrated herein, any number of devices may be implemented, in whole or in part, to facilitate or otherwise support one or more techniques or processes associated with RFS system 400. These are merely example implementations, and claimed subject matter is not limited in this regard.

Although specific implementations have been illustrated and described herein, any arrangement that achieve the same purpose, structure, or function may be substituted for the specific implementations shown. This application is intended to cover any adaptations or variations of the example implementations described herein. These and other implementations are within the scope of the following claims and their equivalents.

### Examples of Further Implementations

The following examples pertain to further implementations. Specifics in the examples may be used anywhere in one or more implementations.

Example 1 is an apparatus that may comprise a refrigeration system and a gas recovery system. The refrigeration system for converting a gas to a liquid comprises a cold box, a subcooling coil, and a storage container. The cold box is for receiving the gas, wherein the gas is received into the cold box by entering a first conduit through a valve. The subcooling coil is for converting the gas into a liquid. The storage container is to store the liquid, wherein the storage container is coupled to the cold box by a second conduit. The gas recovery system is to capture ambient boil-off gas from the storage container. The gas recovery system comprises a compressor to compress the boil-off gas into a second liquid, the second liquid to be fed into the refrigeration system through a third conduit.

In Example 2, the compressor of the apparatus of Example 1 may further be a screw compressor.

In Example 3, the gas recovery system of the apparatus of Example 1 may further comprise a low-pressure buffer tank and a medium-pressure buffer tank. The low-pressure buffer tank is to receive the ambient boil-off gas from the storage container, wherein the low-pressure buffer tank is coupled to the compressor. The medium-pressure buffer tank is to receive the second liquid from the compressor, wherein the medium-pressure buffer tank is coupled to the valve.

In Example 4, the subcooling coil of the apparatus of Example 1 further comprises a first temperature loop comprising refrigerant at a first temperature, wherein the refrigerant at the first temperature cools the gas.

In Example 5, the first temperature of the apparatus of Example 4 is in a range between 50° K and 150° K.

In Example 6, the first temperature of the apparatus of Example 5 is around 80° K.

In Example 7, the subcooling coil of the apparatus of Example 4 further comprises a second temperature loop comprising refrigerant at a second temperature, wherein the refrigerant at the second temperature cools the gas.

In Example 8, the second temperature of the apparatus of Example 7 is in a range between 15° K and 30° K.

In Example 9, the second temperature of the apparatus of Example 8 is around 20° K.

In Example 10, the refrigerant of the apparatus of Example 4 comprises cryogenic helium gas.

In Example 11, the apparatus of Example 3 further comprises an alternative refrigeration system comprising a liquid pump to pump the liquid from the storage container to a dispenser station.

In Example 12, in the apparatus of Example 11, non-ambient boil-off gas venting from the liquid pump is fed into the low-pressure buffer tank.

In Example 13, in the apparatus of Example 11, the alternative refrigeration system further comprising an ambient vaporizer coupled between the liquid pump and the dispenser station, the ambient vaporizer to convert the liquid to a gas.

In Example 14, the apparatus of Example 1 further comprises a fuel cell to be used as a power source.

In Example 15, the apparatus of Example 1 is powered using local mains electricity.

Example 16 is a cryogenic refrigerator for use in a reliquefaction, storage, and filling system, the cryogenic refrigerator comprising a compressor to reduce a pressure of an incoming refrigerant, a cold box to cool the refrigerant to a cryogenic temperature, the cold box comprising a plurality of heat exchangers and a plurality of cryogenic turboexpanders, a buffer tank to store a portion of the refrigerant before being received into the cold box, a first valve to enable flow of the refrigerant into the cold box, and a second valve to enable flow of the refrigerant into the buffer tank.

In Example 17, the cryogenic refrigerator of Example 16 further comprises a first heat exchanger to receive the refrigerant from the compressor and a second heat exchanger to receive the refrigerant from the cryogenic turboexpander.

In Example 18, the cryogenic refrigerator of Example 16 further comprises an oil recovery system coupled to the compressor, the oil recovery system comprising a plurality of filters, the oil recovery system to remove oil from the refrigerant.

In Example 19, in the cryogenic refrigerator of Example 18, the plurality of filters further comprising a coalescing filter and a carbon filter.

In Example 20, in the cryogenic refrigerator of Example 16, the compressor is an oil-flooded screw compressor.

What is claimed is:

1. An apparatus comprising:
a refrigeration system to convert a gas to a liquid, the refrigeration system comprising:
a cold box to receive the gas, wherein the gas is to be received into the cold box via an entrance to a first conduit through a valve;
a subcooling coil to convert the gas into the liquid;
a storage container to store the liquid, wherein the storage container is to be coupled to the cold box via a second conduit; and
a gas recovery system to capture ambient boil-off gas from the storage container, the gas recovery system comprising at least a compressor to compress the boil-off gas into a second liquid to be fed into the refrigeration system through a third conduit.

2. The apparatus of claim 1, wherein the compressor comprises a screw compressor.

3. The apparatus of claim 1, the gas recovery system further comprising:
a low-pressure buffer tank to receive the ambient boil-off gas from the storage container, wherein the low-pressure buffer tank is to be coupled to the compressor; and
a medium-pressure buffer tank to receive the second liquid from the compressor, wherein the medium-pressure buffer tank is to be coupled to the valve.

4. The apparatus of claim 1, wherein the subcooling coil further comprises a first temperature loop with refrigerant at a first temperature, wherein the refrigerant at the first temperature to cool the gas at a first pre-determined threshold.

5. The apparatus of claim 4, wherein the first temperature is to be in a range between 50° K and 150° K.

6. The apparatus of claim 5, wherein the first temperature is around 80° K.

7. The apparatus of claim 4, wherein the subcooling coil further comprises a second temperature loop with refrigerant at a second temperature, wherein the refrigerant at the second temperature to cool the gas at a second pre-determined threshold.

8. The apparatus of claim 7, wherein the second temperature is to be in a range between 15° K and 30° K.

9. The apparatus of claim 8, wherein the second temperature is around 20° K.

10. The apparatus of claim 4, wherein the refrigerant comprises cryogenic helium gas.

11. The apparatus of claim 3, and further comprising an optional refrigeration system comprising a liquid pump to pump the liquid from the storage container to a dispenser station.

12. The apparatus of claim 11, wherein the optional refrigeration system comprises non-ambient boil-off gas venting from the liquid pump is to be fed into the low-pressure buffer tank.

13. The apparatus of claim 11, the optional refrigeration system further comprising an ambient vaporizer to be coupled between the liquid pump and the dispenser station, the ambient vaporizer to convert the liquid to the gas.

14. The apparatus of claim 1, and further comprising a fuel cell to be used, at least in part, as a power source.

15. The apparatus of claim 1, wherein the apparatus is to be powered, at least in part, via local mains electricity.

16. A cryogenic refrigerator for reliquefaction, storage, and/or filling system, the cryogenic refrigerator comprising:
a compressor to reduce a pressure of a refrigerant;
a cold box to cool the refrigerant to a cryogenic temperature within a pre-determined range, the cold box comprising a plurality of heat exchangers and a plurality of cryogenic turboexpanders;
a buffer tank to store a portion of the refrigerant before being received by the cold box;
a first valve to facilitate flow of the refrigerant into the cold box; and
a second valve to facilitate flow of the refrigerant into the buffer tank.

17. The cryogenic refrigerator of claim 16, and further comprising:
a first heat exchanger to receive the refrigerant from the compressor; and
a second heat exchanger to receive the refrigerant from the cryogenic turboexpander.

18. The cryogenic refrigerator of claim 16, and further comprising an oil recovery system coupled to the compressor, the oil recovery system comprising a plurality of filters, the oil recovery system to at least remove oil from the refrigerant.

19. The cryogenic refrigerator of claim 18, wherein the plurality of filters comprises at least a coalescing filter and a carbon filter.

20. The cryogenic refrigerator of claim 16, wherein the compressor comprises an oil-flooded screw compressor.
